(19) United States
(12) Patent Application Publication
(10) Pub. No.: US 2017/0326573 A1
(43) Pub. Date: Nov. 16, 2017

(54) SPRAY BOOTH VENTILATION

(71) Applicant: SPRAYBOOTH TECHNOLOGY LIMITED, Suffolk (GB)

(72) Inventor: Michael WILLIAMS, Suffolk (GB)

(21) Appl. No.: 15/515,691

(22) PCT Filed: Oct. 23, 2015
(86) PCT No.: PCT/GB2015/053177

§ 371 Date: Mar. 30, 2017

(30) Foreign Application Priority Data
Nov. 6, 2014 (GB) 1419803.0

(51) Int. Cl. B05B 15/12; F24F 7/007; F24F 3/16; F24F 7/00; B05B 15/00; F23J 11/00

(52) U.S. Cl. CPC B05B 15/1248; F24F 7/007; F24F 3/1603; B05B 15/00; F23J 11/00; F24F 7/00

(57) ABSTRACT

A spray booth for providing a controlled environment for spraying of material comprises a roof portion (31), a side portion which extends from the roof portion to a floor, first and second end portions which extend from respective opposing ends of the roof portion to the floor, the roof portion, side portion and first and second end portions thereby defining a work space (21) having a substantially closed side, a pair of substantially closed ends, and a substantially open side, air input equipment (34) operable to provide an input airflow into the work space via the roof portion (31), and air extraction equipment (32,37,38,33) operable to produce an output airflow to extract air from the work space. In use, the volume flow rate of the input airflow is larger than the volume flow rate of the output airflow, creating an outpour of excess of input air acting as an air curtain (23) on the open side.

### BACKGROUND OF THE INVENTION

A spray booth is a structure that provides a ventilated, air filtered and temperature controlled environment in which spraying activities such as painting and powder coating can take place. A spray booth is necessary for the safe execution of such activities, since the sprayed materials include solvents and particulate material that must not enter the atmosphere in large quantities. The particulate material that does not stick to the article being sprayed must be removed from the spraying area to ensure safe working conditions, and to manage environmental impact.

A spray booth also provides a controlled supply of filtered air that aids the spraying process and leads to higher quality finishes. In addition, it is necessary to heat sprayed materials in order to dry them (in a process known as baking), and a spray booth typically provides a controlled temperature environment in which such baking can be undertaken.

In the automotive sector, a body shop which repairs and repaints cars and other vehicles may have the need to prepare and spray small components, such as wheels. Using a spray booth designed for spraying of whole vehicles is wasteful in several respects; the energy requirements for the booth are high, relative to the objects being sprayed, the size of the booth significantly exceeds that required for the smaller objects, and the use of a full booth for smaller jobs creates organizational issues for the spray booth operator.

Accordingly, it is desirable to provide a spray booth arrangement that is tailored for smaller objects, in order to enable higher efficiency in processing of those smaller objects, whilst providing the required controlled environments for spraying and finishing at a reasonable cost.

### SUMMARY OF THE INVENTION

According to a first aspect of the present invention, there is provided a spray booth for providing a controlled environment for spraying of material, the spray booth comprising a roof portion, a side portion which extends from the roof portion to a floor, first and second end portions which extend from respective opposing ends of the roof portion to the floor, the roof portion, side portion and first second end portions thereby defining a work space having a substantially closed side, a pair of substantially closed ends, and a substantially open side, air input equipment operable to provide an input airflow having an input volume flow rate into the work space via the roof portion, and air extraction equipment operable produce an output airflow having an output volume flow rate to extract air from the work space, wherein, in use, the input volume flow rate is larger than the output volume flow rate.

In one example, the input volume flow rate is at least twice the output volume low rate. The roof portion may define a plenum into which the airflow is supplied. The air input equipment may comprise a fan unit mounted on the roof portion.

The air extraction equipment comprises an extraction aperture located in the side portion, a fan unit located outside of the workspace, extraction ducting extending from the extraction aperture to the fan unit, and an extraction filter. An air outlet may be connected with the fan unit, and arranged for connection to an air outlet chimney.

According to a second aspect of the present invention, there is provided a kit of parts for a spray booth in accordance with the first aspect of the present invention.

### BRIEF DESCRIPTION OF THE DRAWINGS

FIG. 1 is a schematic side view of a spray booth arrangement embodying aspects of the present invention;

FIG. 2 is a schematic cross-sectional view of the spray booth arrangement of FIG. 1;

FIG. 3 is a schematic plan view of the spray booth arrangement of FIG. 1;

FIG. 4 is a schematic plan view of an oven component of the spray booth arrangement of FIG. 1;

FIG. 5 is a schematic cross-sectional side view of the oven component of FIG. 4;

FIG. 6 is a schematic cross-sectional view of the component of FIGS. 4 and 5 in a closed configuration;

FIG. 7 is a schematic cross-sectional view of the component of FIGS. 4 and 5 in an open configuration; and

FIGS. 8 to 14 are schematic views illustrating operation of the arrangement of FIGS. 1 to 7.

### DETAILED DESCRIPTION OF THE PREFERRED EMBODIMENTS

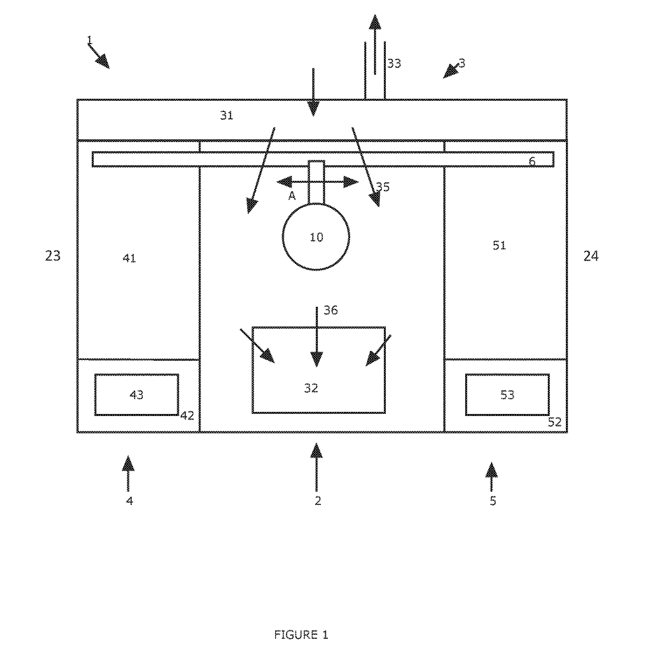

FIG. 1 illustrates a spray booth arrangement embodying various aspects of the present invention. The arrangement 1 comprises a centrally located work space 2, with first and second ovens 4 and to respective sides of the work space 2. Air handling plant 3 provides clean air input into, and air extraction out of, the work space 2. A workpiece transfer rail 6 extends between the work space 2 and the first and second ovens 4 and 5, and is used to transfer a workpiece

between those areas, as will be described in more detail below.

The air handling plant 3 comprises an air inlet region 31, which provides air 35 into the work space 2, and an air extraction filter 32 through which air 36 is extracted from the spray booth zone 2.

The ovens 4 and 5 each incorporate a high temperature baking zone 41, 51, and a lower temperature curing zone 42, 52. Each oven 4, 5 is provided with a door 43, 53 to enable access to the curing zone 42, 52.

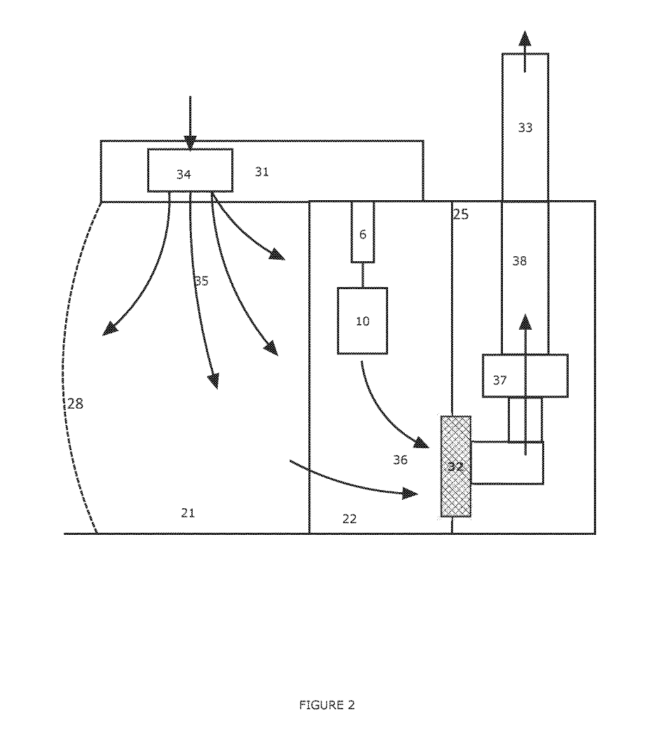

FIG. 2 is a schematic side cross sectional view of the spray booth zone 2 of the spray booth arrangement of FIG. 1. The work space 2 has two regions—a work zone 21 which extends in front of the two ovens 4 and 5), in which an operative is located during use of the booth, and a spraying region 22, in which a workpiece 10 is located during spraying thereof.

The work space 2 is provided with air handling plant 3 which is operable to provide clean air input into the work space 2, and to extract contaminated air from the work space 2, and in particular from the spraying region 22.

The air handling plant 3 comprises an inlet fan 34 which draws clean air in from outside of the spray booth and passes this clean air into an inlet plenum 31 which extends across the ceiling area of the spray booth work zone 21. The inlet fan 34 preferably includes an air filter or filters in order that the air input into the work space 2 is cleaned to a required standard.

An air extraction port 32 is provided in a side wall 25 of the spraying region 22. An air extraction fan 37 draws air 36 through the extraction port 32, through ducting 38, and causes the air to be expelled from the spray booth arrangement 1 via a chimney 33. The extraction port 32, the extraction fan 37 and/or the ducting 38 preferably includes one or more filter elements for removal of contaminants from the extracted air before release from the arrangement 1. In many installations it is required that the air being expelled from the arrangement has a significantly reduced level of contamination, and so suitable filtration may be provided in the extraction part of the air handling plant 3.

The transfer rail 6 extends through the spraying region 22, such that a workpiece 10 can be sprayed and worked on in a filtered controlled air environment. A worker (not shown for clarity) is able to spray the workpiece 10 as it is suspended from the transfer rail 6 in the spraying region 22 from the work zone 21. Any appropriate spraying process may be carried out in the spraying area, for example spraying of water or other liquid based paints, or powder coating in which dry particulate material is sprayed onto the workpiece 10.

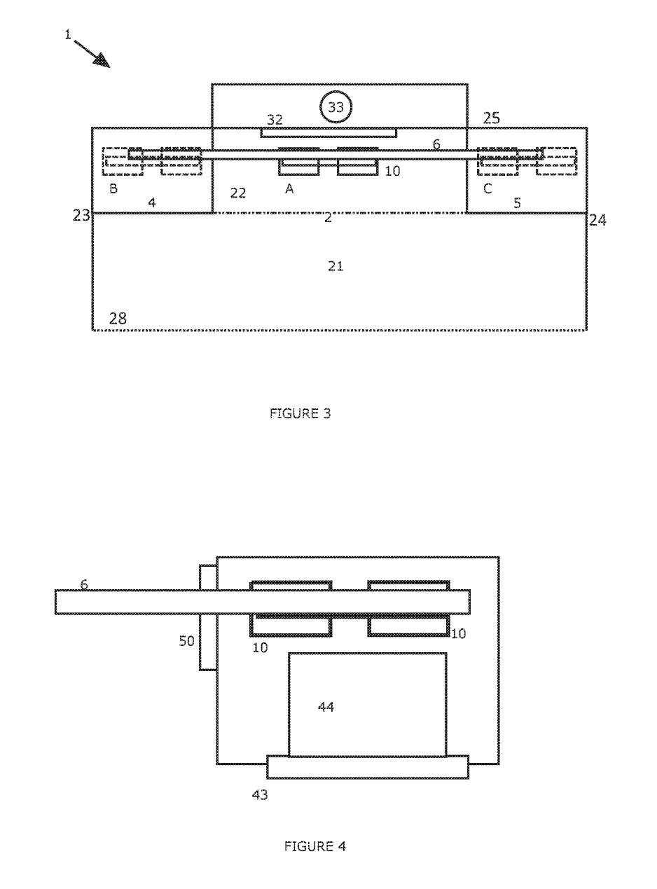

FIG. 3 is a schematic plan view of the spray booth arrangement 1 of FIGS. 1 and 2. As can be seen more clearly from FIG. 3, the spray booth arrangement 1 is bounded by end walls 23 and 24, and by a side wall 25. A roof portion extends over the arrangement 1. The work space 2 is located in a central region of the arrangement 1 and includes the work zone 21 and the spraying zone 22. As described above, the work space 2 is bounded at each end by an oven 4, 5. Each oven defines a self-contained volume, separated from rest of the spray booth arrangement 1 by way of insulated walls. Each oven includes a sliding door to enable a workpiece to be moved into and out of the oven from the spraying region 22 of the work space 2 using the rail 6. In FIG. 3, the work piece 10 is shown in a spraying position (A), and can be moved to the first oven 4 (position B) or to the second oven 5 (position C). More detailed description of the ovens and the overall operation of the arrangement is set out below.

The spray booth arrangement shown in FIGS. 1, 2 and 3 has an open side opposite to the spraying zone 22 and ovens 4 and 5. This open side enables work pieces to be transferred into and out of the spray booth arrangement 1 with ease and high efficiency. However, having such an open side may cause problems with the cleanliness of the air within the work space 2.

Accordingly, in an embodiment of one aspect of the present invention, the flow rate of clean air input to the work space 2 is higher than the rate of extraction of air from the spraying zone 22 of the work space 2. In one preferred example, the flow of air into the work space 2 is approximately twice the flow rate of air extracted through the extraction port 32. For example, the input flow rate may be approximately 30000 m³/hr with the extraction rate of approximately 15000 m³/hr. This difference in flow rates results in a flow of clean air out of the open side of the spray booth arrangement 1, which provides an air curtain 28. This air curtain 28 provides a barrier that serves to prevent ingress of contaminants from outside of the spray booth arrangement 1 through the open side thereof. The extraction flow rate is chosen such that all, or substantially all, of the contaminated air from the spraying region 22 is removed from the work space 2, without reaching the work region 21. In this way, any release of contaminated air can be closely controlled.

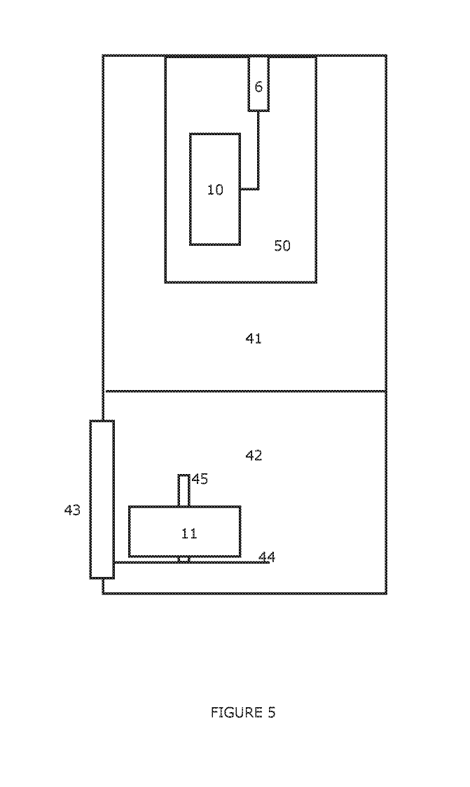

FIGS. 4 and 5 are schematic cross sectional plan and end views respectively of the first oven 4. It will be readily appreciated that the second oven 5 is preferably identical in construction and arrangement to the first oven 4.

In accordance with another aspect of the present invention, the oven 4 defines a high temperature baking zone 41, and a lower temperature curing zone 42. The baking zone 41 is arranged above the curing zone, and operates at a temperature higher than that of the curing zone. The transport rail 6 extends into the baking zone 41. An opening in a side wall of the baking zone 41 is provided, and is positioned such that a workpiece 10 can be moved into and out of the baking zone 41 using the transport rail 6. A sliding door 50 is used to selectively close the opening into the baking zone 41 of the oven 4.

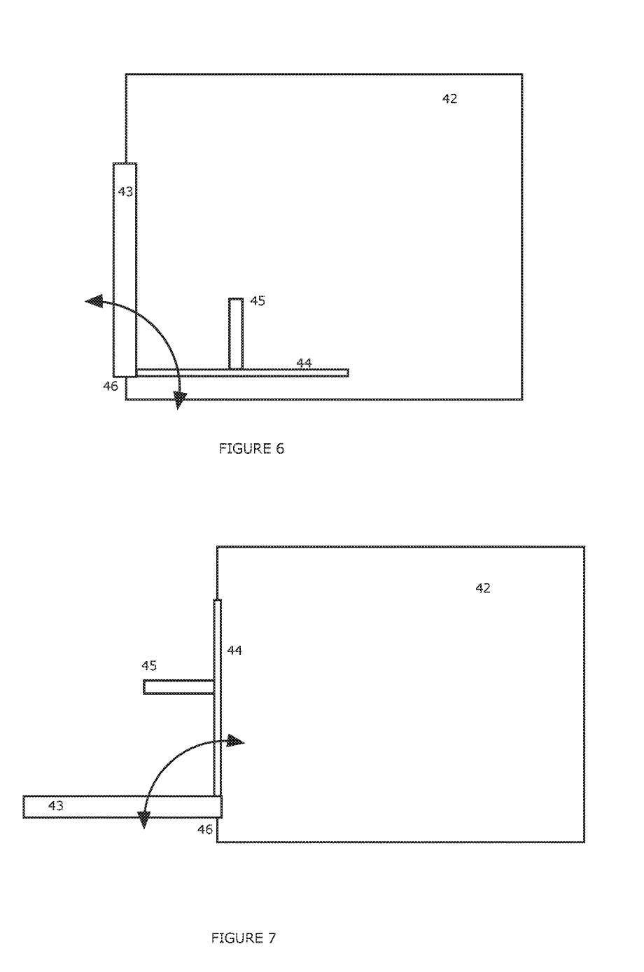

In addition, the oven 4 is provided with a lower door 43 to enable access thereto from the work space 21. The lower door 43 is combined with a workpiece support 44, which is attached to the lower door 43, and which extends into the curing zone 42 when the lower door 43 is closed. The workpiece support 44 may be provided with an upstand 45 on which a workpiece 11 is supported. Operation of the lower door 43 and workpiece support 44 will described below with reference to FIGS. 6 and 7.

FIGS. 6 and 7 illustrate the curing zone of the oven 4, 5 in closed and open configurations respectively. The lower door 43 is rotatably attached to the oven structure by way of a pivotable hinge 46. The workpiece support 44 is attached to the lower door 43 and extends into the curing zone 42 from the lower door 43.

The lower door is movable between the closed (FIG. 6) configuration, and open (FIG. 7) configuration by rotating the lower door 43 about the hinge 46, as shown by arrow 47 in FIGS. 6 and 7.

When the oven door is in the open position as shown in FIG. 7, the curing zone of the oven is closed, thereby reducing heat loss from the oven. In addition, the workpiece support 44 and upstand 45 are available to the operator for location or removal of the workpiece (not shown for clarity in FIG. 7).

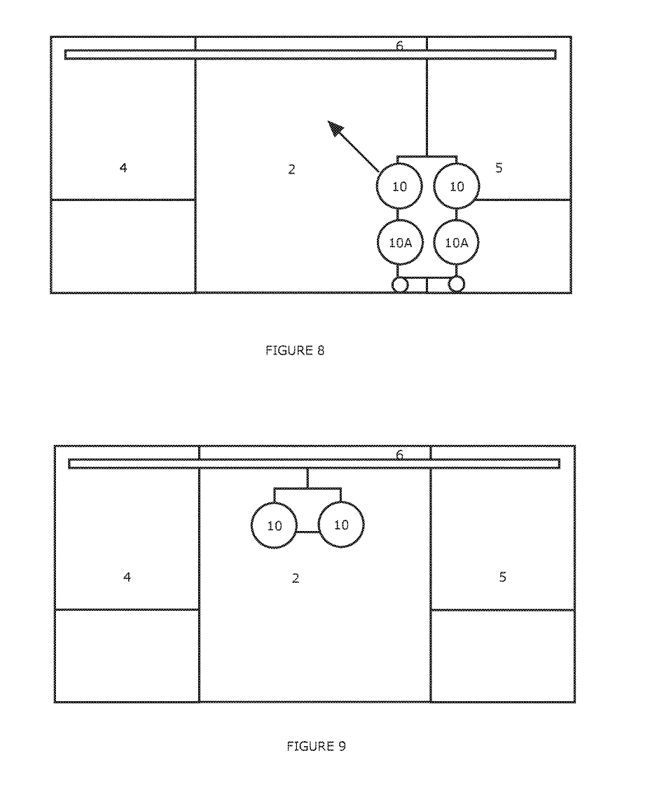

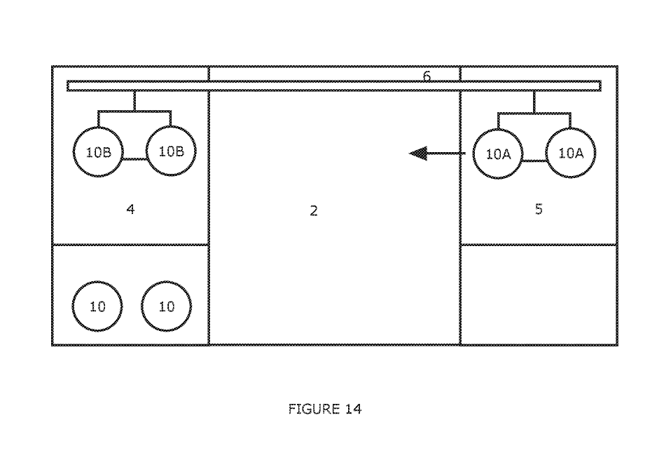

Processing of workpieces will now be described with reference to the schematic views of FIGS. 8 to 14. At a first stage of the process, a number of workpieces 10, 10A are delivered to the workspace, preferably on a wheeled trolley (FIG. 8). In the present example, the workpieces are vehicle wheels, which are process in pairs. An important application of the arrangement and process described herein is to the refurbishment of wheels for cars, which are most commonly processed in two pairs. It will be readily appreciated that the principles of operation described herein are applicable to any type and number of workpieces.

A first pair of wheels 10 is loaded onto a frame on the transport rail 6 in the spraying zone 22 (FIG. 9). The frame may be provided as a removable part of the trolley on which the wheels 10 are delivered, or may be separate from the trolley. The trolley carrying the second pair of wheels 10A is not shown in FIG. 9 for the sake of clarity. The operator is then able to undertake a spraying operation, be that paint spraying or powder coating, while the wheels are in the spraying zone 22. During this operation, the air handling equipment described above is providing a clean air environment in the work space 2.

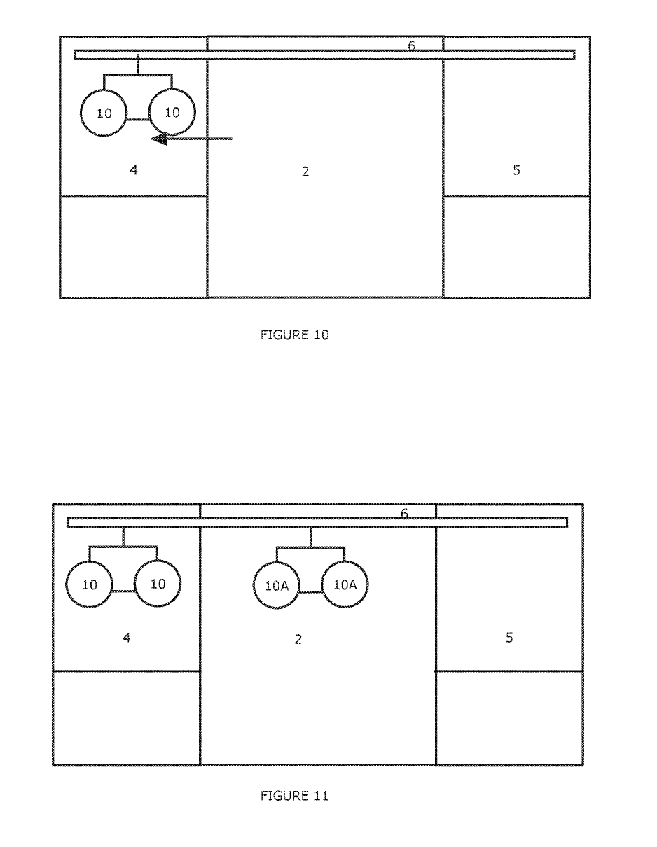

Once the first pair of wheels 10 have been sprayed, they are moved into the baking zone of one of the ovens, in this case the first oven 4 (FIG. 10). The upper door of the first oven 4 is opened and the frame carrying the wheels 10 is moved along the transport rail 6 so that the wheels 10 are located within the baking zone of the first oven 4. The upper door is then closed and the first oven can be operated to bake the wheels 10 at the appropriate temperature for the appropriate time.

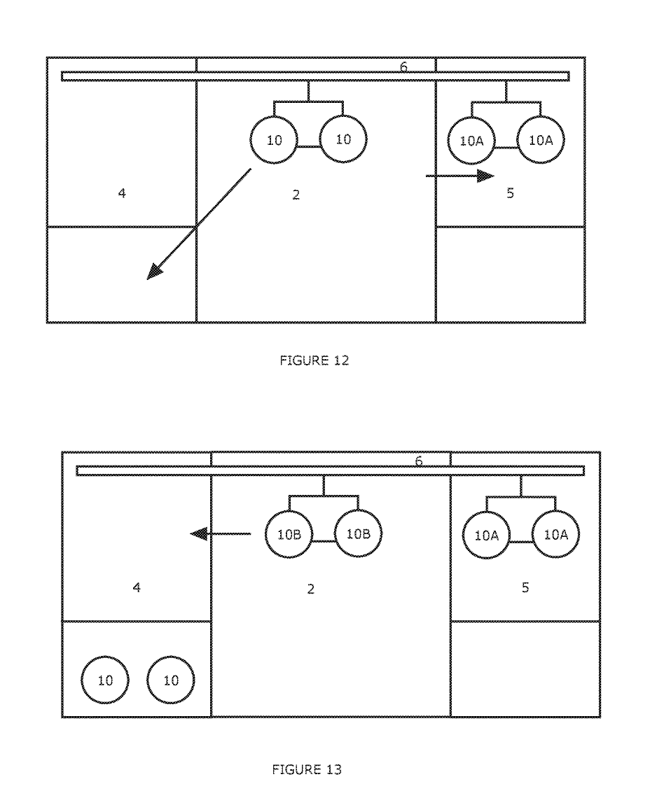

Now that the spraying zone 22 is free, a second pair of wheels 10A is loaded onto the transport rail 6 (FIG. 11) in the spraying zone 22 for spraying and processing by the operator. During this processing, the first pair of wheels 10 is being baked in the first oven 4. As such, the arrangement described enables different operations to be carried out in parallel with one another, thereby contributing to increased throughput and efficiency. Following completion of the spraying operation on the second pair of wheels 10A, those wheels are moved along the transport rail 6 into the baking zone of the second oven 5. The spraying zone 22 is then free, and the first pair of wheels 10 can be moved into that zone 22 when the baking operation in the first oven 4 is completed (FIG. 12).

Some finishing operations require a second spraying stage, and that can now be completed in the spraying zone 22 for the first pair of wheels 10. The first pair of wheels may then be returned to the oven 4 for a further baking stage. Alternatively, the first pair of wheels 10 may require curing in the curing zone of the first oven 4 (the curing zone of the second oven 10 may be used), and so this first pair of wheels 10 is moved by the operator to that curing zone.

Once the first pair of wheels 10 has been moved out of the spraying zone 22 into the curing zone of the first oven 4, then the spraying zone 22 is again free for use. A third pair of wheels 10B may then be placed in the spraying zone 22 for processing while the second pair of wheels 10A are baked in the second oven 5. Such a situation is illustrated in FIG. 13. Following spraying, the third pair of wheels 10B are moved into the first oven for baking. The second pair of wheels 10A can be removed from the second oven 5, and then handled appropriately, for example being placed in the curing zone, thereby enabling a further pair of wheels to be processed and baked.

As will be readily appreciated, the arrangement described above enables increases in efficiency in the processing of workpieces, such as wheels, by enabling the workpieces to be transported between processing locations easily, using the transport rail, and by enabling processing to be carried out in parallel. That is the baking and curing ovens are separate to the spraying zone, thereby enabling baking and curing to carry on in parallel with one another and with a spraying process on another workpiece.

1. An open spray booth for providing a controlled environment for spraying of material, the spray booth comprising:
a roof portion;
a side portion which extends from the roof portion to a floor;
first and second end portions which extend from respective opposing ends of the roof portion to the floor, the roof portion, side portion and first and second end portions thereby defining a work space having a substantially closed side, a pair of substantially closed ends, and a side substantially open to the outside of the booth, the work space including a work zone in which an operative is located during use of the spray booth, and a spraying region in which a workpiece is located during spraying thereof;
air input equipment operable to provide an input airflow at an input volume flow rate into the work space via the roof portion; and
air extraction equipment operable to extract an output airflow at an output volume flow rate from the spraying region of the work space,
wherein, in use, the input volume flow rate is larger than the output volume flow rate.

2. A spray booth as claimed in claim 1, wherein the input volume flow rate is at least twice the output volume flow rate.

3. A spray booth as claimed in claim 1, wherein the roof portion defines a plenum into which the airflow is supplied.

4. A spray booth as claimed in claim 1, wherein the air input equipment comprises a fan unit mounted on the roof portion.

5. A spray booth as claimed in claim 1, wherein the air extraction equipment comprises an extraction port located in the side portion, a fan unit located outside of the workspace, extraction ducting extending from the extraction aperture to the fan unit, and an extraction filter.

6. A spray booth as claimed in claim 5, wherein the air extraction equipment comprises an extraction port located in the side portion, a fan unit located outside of the workspace, extraction ducting extending from the extraction aperture to the fan unit, and an extraction filter, the spray booth further comprising an air outlet connected with the fan unit, and arranged for connection to an air outlet chimney.

7-8. (canceled)
